(19) United States
(12) Patent Application Publication
(10) Pub. No.: US 2008/0064800 A1
(43) Pub. Date: Mar. 13, 2008

(54) Poly(vinyl butyral) Dispersions Comprising a Non-Ionic Surfactant

(76) Inventors: Bruce Edward Wade, West Springfield, MA (US); Mike Yi Ren Chen, West Springfield, MA (US)

Correspondence Address: BRENC LAW;ANDREW BRENC, P.O. BOX 155, ALBION, PA, 16401-0155, US

(21) Appl. No.: 11/530,455

(22) Filed: Sep. 8, 2006

(51) Int. Cl. C08K 5/00

(52) U.S. Cl. 524/284; 524/563

(57) ABSTRACT

The present invention is directed to poly(vinyl butyral) dispersions that incorporate a hydrogenated, ethoxylated castor oil as a non-ionic surfactant. Incorporation of the hydrogenated, ethoxylated castor oils of the present invention result in poly(vinyl butyral) dispersions that can be formed using conventional methods. Non-ionic, hydrogenated, ethoxylated castor oils, according to the present invention, can be post-added after formation of an anionic dispersion as a co-surfactant to extend pH stability of a poly(vinyl butyral) dispersion containing a conventional anionic alkali-metal soap, such as sodium or potassium oleate, from the alkaline to the neutral pH range.

### FIELD OF THE INVENTION

The present invention is in the field of polymer dispersions, and, in particular, the present invention is in the field of poly(vinyl butyral) polymer dispersions that can be applied to the surfaces of items to provide a physical barrier or to be a binder.

### BACKGROUND

Polymer dispersions have conventionally been used for a wide array of applications, including, for example, as a protective, temporary film coating, as paint masking, as spray booth coating, for equipment protection, and for surface decontamination.

One conventional method for producing an emulsion of plasticized polymer-in-water involves mixing polymer, plasticizer, and surfactant to form a weld. The weld is then mixed while sufficient water is added to cause an inversion to a plasticized polymer-in-water emulsion or abbreviated oil-in-water emulsion (see, for example, U.S. Pat. No. 2,487,254). The oil-in-water emulsion can then, for example, be sprayed on a surface for which protection is desired, thereby forming a layer. After formation of the layer, water will readily evaporate or be absorbed into an adjacent fibrous layer, resulting in a continuous layer of polymer on the surface.

Conventional polymer dispersions (see, for example, U.S. Pat. No. 2,487,254 or 2,532,223) can employ one or more of many known anionic surfactants, including, for example, carboxylate, sulfate, sulfonate or phosphate as polar groups in the surfactant molecule. The counterions most commonly used are sodium, potassium, ammonium, calcium and various protonated alkyl amines. Sodium or potassium salts of fatty acids or alkali-metal soaps were the first surfactants known and are still the most widely used. The raw materials, oleic acid containing animal fats or plant derived oils and alkali, are economical and environmentally sustainable. Sodium or potassium oleates as derived from saponification of animal fats (tallow) or plant derived (vegetable or tall) oils with sodium or potassium hydroxide are examples of carboxylate containing anionic surfactants, which are also called soaps. A problem with polymer dispersions using these conventional alkali-metal soaps or the corresponding ammonium, calcium, or protonated alkyl amine oleates as anionic surfactants, however, is that they typically require a pH in the alkaline range, for example 8 to 11, or the emulsion breaks because the alkali-metal soap is converted back to the water-insoluble fatty acid.

What are needed in the art are poly(vinyl butyral) dispersion formulations that have a neutral or near neutral pH that also have desirable physical characteristics, such as low viscosity and a high content of solids in dispersions.

### SUMMARY OF THE INVENTION

The present invention is directed to poly(vinyl butyral) dispersions that incorporate a hydrogenated, ethoxylated castor oil as a non-ionic surfactant. Incorporation of the hydrogenated, ethoxylated castor oils of the present invention result in poly(vinyl butyral) dispersions that can be formed using conventional methods. Non-ionic, hydrogenated, ethoxylated castor oils, according to the present invention, can be post-added after formation of an anionic dispersion as a co-surfactant to extend pH stability of a poly(vinyl butyral) dispersion containing a conventional anionic alkali-metal soap, such as sodium or potassium oleate, from the alkaline to the neutral pH range.

### DETAILED DESCRIPTION

Poly(vinyl butyral) dispersions of the present invention comprise water, a poly(vinyl butyral) resin, a surfactant, and, optionally, one or more plasticizers or other agents.

The present invention is directed to poly(vinyl butyral) dispersions comprising the following non-ionic surfactant:

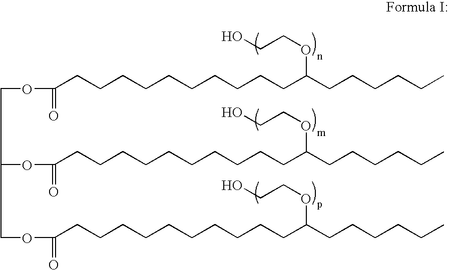

where the sum of n, m, and p is, in various embodiments, 36-81 and n, m, and p each are 12 to 27, 15 to 25, 18 to 22, or 20. In other embodiments, the sum of n, m, and p is, in various embodiments, 45-75 and n, m, and p each are 15 to 25, 18 to 22, or 20.

In various embodiments, the sum of n, m, and p from 36-81 respectively corresponds to hydroxyl values ranging from 66.6 to 37.3 milligrams potassium hydroxide per gram of hydrogenated, ethoxylated castor oil as sometimes reported by commercial titration specifications.

The surfactant of Formula I can be incorporated into polymer dispersions of the present invention in any suitable amount, including, for example, 0.5 to 20 phr or 0.5 to 10 phr, with “phr” meaning parts per one hundred parts resin.

Variations of the surfactant of Formula I is available commercially from Ethox Chemicals (Greenville, S.C.) as HCO-60, from BASF as Cremophor RH 60, and from Clariant Corporation as Emulsogen HCO 060.

The poly(vinyl butyral) dispersions of the present invention comprising Formula I can be poly(vinyl butyral) suspensions or poly(vinyl butyral) emulsions. As used herein, a “poly(vinyl butyral) emulsion” refers to poly(vinyl butyral) that has been plasticized with an oil, for example castor oil, and then emulsified in water. As used herein, a “poly(vinyl butyral) suspension” refers to poly(vinyl butyral) that has not been plasticized with an oil and that has been dispersed in water. Poly(vinyl butyral) dispersions include both poly(vinyl butyral) emulsions and poly(vinyl butyral) suspensions.

The polymeric component of dispersions of the present invention can comprise any suitable poly(vinyl butyral) resin, which may vary substantially in their composition. Thus, in some embodiments, poly(vinyl butyral)s may be used that have up to 30% hydroxyl groups by weight, calculated as poly(vinyl alcohol), up to 30% ester groups by weight, calculated as polyvinyl ester, and the balance substantially butyraldehyde acetal. In various embodiments, poly(vinyl butyral) containing more than 9% hydroxyl groups by weight, but not more than 25% hydroxyl groups, calculated as poly(vinyl alcohol), can be used.

According to further embodiments of the present invention, the poly(vinyl butyral) contains 10-20% hydroxyl groups by weight, calculated as poly(vinyl alcohol), less than 5% acetate groups by weight, calculated as poly(vinyl acetate), with the balance substantially butyraldehyde acetal.

The polyvinyl esters from which the poly(vinyl butyral)s are made may have widely varying degrees of polymerization as evidenced by the viscosities of solutions thereof. For example, poly(vinyl acetate)s that are used as a starting material in the sequential processes of hydrolysis and acetalization to manufacture poly(vinyl butyral) may be used. Other polyvinyl esters may vary correspondingly. In various embodiments, the resultant polymer used in the dispersion manufacture process has a weight average molecular weight of at least 40,000 Daltons to produce films or to be a binder with desirable mechanical properties.

The ester groups in the poly(vinyl butyral)s are usually acetate groups, but the acetate groups may be wholly or partially replaced by other ester groups such as formate, propionate, butyrate, benzoate, and the like.

Poly(vinyl butyral) resins can be incorporated into polymer dispersions in any suitable amount, with the end product having a percent solids concentration of, for example, from 10% to 70% solids, 40% to 70% solids, 20% to 60% solids, or 40% to 60% solids on a weight per weight basis, with “solids” being defined as the total weight of polymer, plasticizer, surfactant, and other agents.

Various poly(vinyl butyral) resins are commercially available from Solutia, Incorporated (St. Louis, Mo.), as Butvar®.

Any suitable poly(vinyl butyral) plasticizer can be used that is hydrolytically stable in the aqueous dispersion. Useful plasticizers include, but are not limited to, triethylene glycol di-2-ethylhexanoate, butyl ricinoleate, castor oil, dihexyl adipate, dioctyl adipate, dibutoxy ethyl phthalate, diethyl phthalate, dibutyl sebacate, dibutyl phthalate, benzyl butyl phthalate, C7-C11 alkyl phthalates, triethylene glycol dihexanoate, triethylene glycol diheptanoate, triethylene glycol ester of coconut oil fatty acids, phenyl ethers of polyethylene oxide rosin derivatives, oil modified sebacic alkyd resins, and the like. Mixes of these and/or other plasticizers may also be employed.

Plasticizers can be incorporated in any suitable amount, including some embodiments in which no plasticizer is used, and these amounts include, for example, up to 100 phr, up to 50 phr, up to 30 phr, or from 5-80 or 10-40 phr plasticizer.

Any suitable co-surfactant may also be employed, in various embodiments, in addition to the surfactant of Formula I, for example, but not limited to, reaction products of strong bases and soap forming organic acids in general, sodium oleate, salts of such bases as the alkali metals, for example sodium hydroxide or potassium hydroxide, ammonium hydroxide or quaternary ammonium bases, for example, triphenyl methyl ammonium hydroxide, tetraethyl ammonium hydroxide, and the like, triethanolamine, morpholine, and the like, made with such organic acids as stearic acid, oleic acid, ricinoleic acid, palmitic acid, lauric acid, dodecyl benzene sulfonic acid, abictic acid, and the like, as well as, generally, aryl alkyl sulfonatic acids. A surfactant that is a combination of an acid and a base may be reacted in-situ in the first zone of an extruder or prior to injection. In various embodiments, a surfactant mixture is produced in-situ from the following combination of organic acids: 73% oleic acid, 8% linoleic acid, 6% palmitoleic acid, 3% myristoleic acid, 1% linolenic acid, and 9% C14-C17 saturated carboxylic acids. Typically, 70-80% oleic acid, 10-15% linoleic acid, 4-6% palmitic acid, 2-4% stearic acid, 1-2% linolenic acid, and the balance other fatty acids.

A co-surfactant can be incorporated in any suitable amount, including, for example, in an amount that, when added to the Formula I surfactant, results in a total surfactant of 0.5 to 30 phr, 0.5 to 20 phr, or 0.5 to 10 phr, depending on the co-surfactant used and the other components of the dispersion.

In various embodiments of the present invention, the non-ionic surfactant of Formula I is used alone or in combination with an anionic oleate soap as a co-surfactant in an amount sufficient to result in a stable poly(vinyl butyral) dispersion at a final pH of the polymer dispersion of 5 to 11 in combination or a pH of 5 to 8 alone with only the non-ionic surfactant.

Other agents and additives can optionally be included to the poly(vinyl butyral) dispersions of the present invention including, but not limited to, fillers, modifying agents, starches, clays, natural gums, synthetic thickeners, pigments, antimicrobial agents, ceramic powders, and the like.

Any suitable method can be used to form the poly(vinyl butyral) dispersions of the present invention.

One conventional method for producing an emulsion of plasticized polymer-in-water involves mixing polymer, plasticizer, and surfactant to form a weld. The weld is then mixed while sufficient water is added to cause an inversion to a plasticized polymer-in-water emulsion or abbreviated oil-in-water emulsion (see, for example, U.S. Pat. No. 2,487,254).

Another method incorporates excess water in the initial mixing step, which results in plasticized polymer-in-water. Sufficient water is then slowly evaporated while mixing and heating, resulting in an inversion to water-in-oil plasticized polymer. Finally, water is added back, with mixing and heating, resulting in a reversion to a final oil plasticized polymer-in-water or an abbreviated oil-in-water emulsion (see, for example, U.S. Pat. No. 2,532,223).

Other conventionally used methods of producing polymer dispersions include using an alkyl aryl alkali metal sulfonate agent and only a single inversion (see, for example, U.S. Pat. No. 2,611,755), as well as using a single inversion in combination with little or no plasticizer (see, for example, U.S. Pat. No. 3,234,161).

In another embodiment, a polymer dispersion is formed by using the continuous, extruder method disclosed in copending U.S. patent application Ser. No. 11/274,534.

A typical method of forming a polymer layer involves spraying the oil-in-water dispersion on a surface for which protection is desired, thereby forming a layer. After formation of the layer, water will readily evaporate or be absorbed into an adjacent fibrous layer, resulting in a continuous layer of polymer on the surface.

Poly(vinyl butyral) dispersions of the present invention can advantageously be used in many applications, including applications that demand low levels of metals and neutral pH.

In particular, dispersions produced by the methods of the present invention can be used in the formation of films or for impregnating and coating fibrous materials, and can also be mixed with inorganic additives such as calcium carbonate, aluminum hydroxide, or metal oxides for forming barrier coatings that can be used for paper and paperboard products. These poly(vinyl butyral) dispersions also can be used to present the polymer and plasticizer uniformly in micron sized micelles as the fugitive binder for ceramic tape casting formulations of ceramic powders to make, for example, electronic components such as capacitors or other ceramic containing substrates.

The present invention includes methods of making polymer dispersions and films comprising incorporating the surfactant of Formula I into a polymer dispersion using any suitable method, and thereafter forming a film using any suitable method.

The present invention includes polymer films formed from any of the poly(vinyl butyral) dispersions of the present invention.

The present invention includes polymer films formed from any of the methods of the present invention.

The present invention includes non-ionic aqueous dispersions that are used as a fugitive binder, for example, in formulations that require low metal ion content such as for ceramic tape casting of metal oxides to make electronic chip substrates or ceramic powders for ceramic capacitors. In these embodiments, up to 100 phr plasticizer is used in the dispersion to reduce the poly(vinyl butyral) glass transition temperature below room temperature. This can be accomplished, for example and without limitation, with a low hydroxyl PVB (11.0 to 13.5% hydroxyl content) such as Butvar® PVB Resin B-76 or B-79 with S-2075 triethylene glycol di-2-ethylhexanoate plasticizer (both available from Solutia, incorporated, St. Louis, Mo.) without separation of the plasticizer from the polymer emulsion. Above approximately 70 parts per hundred resin S-2075, exudation of this plasticizer occurs from the polymer emulsion produced with a high hydroxyl poly(vinyl butyral) (18.0 to 20.5% hydroxyl content) such as Butvar® PVB Resin B-90 or B-98 due to lesser compatibility of the plasticizer with the higher hydroxyl containing poly(vinyl butyral).

### EXAMPLE 1

The following procedure is used to prepare several test dispersions, each with a different non-ionic surfactant:

A premix of 76.7 grams of water, 383.4 grams of poly(vinyl butyral) resin (Butvar® PVB Resin B-98, Solutia, St. Louis, Mo.), 191.7 grams of triethylene glycol di-2-ethylhexanoate plasticizer, and surfactant is charged into a 946.4 milliliter Baker-Perkins kneader and mixed for 15 minutes. While mixing, the jacket of the kneader is heated using an oil circulation bath to maintain the premix at a temperature of 90° C. Ram pressure of 6,894.7 to 20,684.1 Pascal (1-3 pounds per square inch) is applied to the top of the kneading product to masticate it with two knobben kneader blades and to obtain a uniform plasticized weld. After a weld is obtained, water is slowly added at 2.88 grams per minute for one hour while maintaining ram pressure. The mixture is visually examined for uniform inversion, with good inversion characterized by a uniform distribution of water and no liquid separation from the weld. The remaining balance of water is then added faster at 8.63 grams per minute for a second hour to complete dilution. After completion of water addition, the dispersion is cooled down to room temperature, transferred to a sealed, one quart container, and allowed to stand for 24 hours. If the dispersion solids do not separate from the liquid phase after 24 hours, it is considered a stable dispersion.

Weight Percent Table

| Component | Weight (grams) | Weight (%) |
|---|---|---|
| Plasticizer | 191.7 | 13.5 |
| Nonionic Surfactant | 77.6 | 5.5 |
| Poly(vinyl butyral) | 383.4 | 27.0 |
| Water | 766.8 | 54.0 |
| Total | 1419.5 | 100.0 |

The following surfactants are found to be acceptable: Ethox HCO-60 [61788-85-0], BASF RH 60 [61788-85-0], Clariant Emulsogen HCO-060 and [61788-85-0].

The following surfactants are found to invert but to be unstable in the dispersed form: Ethox CO-81 [61791-12-6], CASCHEM Surfactol 365 [61791-12-6], and Lambent Lumulse HCO-50 [61788-85-0].

The following surfactants fail to invert: Ethox ML-14 [61791-29-5] Clariant Genapol PF 40 [9003-11-6], CASCHEM Surfactol 318 [61791-12-6], Ethox Ethsorbox 0-20 [9005-65-6].

### EXAMPLE 2

An alkaline anionic aqueous emulsion of poly(vinyl butyral) (Butvar® RS-3120) is diluted with 50 weight percent water. The non-ionic surfactant is added to achieve a 2.5 weight percent concentration in the mixture. The mixture is mixed until the surfactant dissolves into the emulsion. No particle agglomeration is observed. The emulsion pH is adjusted to a pH of 6 by adding a 2.5% H₂SO₄ drop by drop into the emulsion while slowly agitating emulsion.

If no particle agglomeration is observed during acid addition or during the 24 hours afterwards, the non-ionic surfactant is considered acceptable as co-surfactant for the alkaline anionic aqueous poly(vinyl butyral) emulsion to make it pH neutrally capable. This example shows that the emulsion is not broken when the alkali-metal soap is converted back to the water-insoluble fatty acid. The non-ionic surfactant of Formula I used in combination with an oleate soap as a co-surfactant is in an amount sufficient to result in a stable poly(vinyl butyral) dispersion also in the neutral pH range.

The following surfactants showed no lumps or agglomeration: Ethox HCO-60 [61788-85-0], BASF RH 60 [61788-85-0], Clariant Emulsogen HCO-060 [61788-85-0].

The following surfactants showed lumps and/or agglomeration: Lambent Lumulse HCO-50 [61788-85-0], Ethox MO-14 [9004-96-0], and Ethox HCO-200 [61788-85-0].

### EXAMPLE 3

A similar procedure as per Example 1 is followed for the component compositions as described in the table below. B-76 is a low hydroxyl poly(vinyl butyral) whereas B-98 is a high hydroxyl poly(vinyl butyral). The total solids target is also higher for this example; a 65.0% target compared to 46.0% in Example 1. The S-2075 plasticizer is at a level of 100 parts per hundred resin, which is twice that of Example 1.

### Dispersion Component Table for Example 3

| Components | Weight (grams) | Weight (%) |
|---|---|---|
| 100 parts per hundred | 425.9 | 30.0 |
| resin S-2075 plasticizer | | |
| BASF HCO-060 | 71.0 | 5.00 |
| Butvar ® PVB Resin B- | 425.9 | 30.0 |
| 98 or B-76 | | |
| Water | 496.8 | 35.0 |
| Total | 1419.5 | 100.0 |

A premix of 49.7 grams of water, 425 grams of poly(vinyl butyral) resin (either Butvar® PVB Resin B-98 or B-76), 425.9 grams of triethylene glycol di-2-ethylhexanoate plasticizer (S-2075 plasticizer from Solutia) and 71.0 grams non-ionic surfactant (RH-60 surfactant from BASF) is charged into a 946.4 milliliter Baker-Perkins kneader and mixed for 15 minutes. While mixing, the jacket of the kneader is heated using an oil circulation bath to maintain the premix at a temperature of 90° C. Ram pressure of 6,894.7 to 20,684.1 Pascals (1-3 pounds per square inch) is applied to the top of the kneading product to masticate it with two knobben kneader blades and to obtain a uniform plasticized weld. After a weld is obtained, water is slowly added at 1.86 grams per minute for one hour while maintaining ram pressure. The mixture is visually examined to identify good inversion. The remaining balance of water is added faster at 5.59 grams per minute for a second hour to complete dilution. After completion of water addition, the dispersion is cooled down to room temperature, transferred to a sealed, one quart container, and allowed to stand for 24 hours.

For the composition with B-98, some of the plasticizer separated to the surface of the finished dispersion after sitting for 24 hours. A cast film, dried at 25° C. overnight from the initial dispersion with B-98 was hazy and oily to the touch. The percent solids measured with the initial dispersion is found to be 62.0%. A stable dispersion with no separation of plasticizer was observed for the case with B-76. The cast film from the dispersion made with B-76 is clear and dry to the touch. The percent solids measured from the initial dispersion containing B-76 is found to be 65.2%.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

It will further be understood that any of the ranges, values, or characteristics given for any single component of the present invention can be used interchangeably with any ranges, values, or characteristics given for any of the other components of the invention, where compatible, to form an embodiment having defined values for each of the components, as given herein throughout. For example, a polymer resin can be formed comprising residual hydroxyl content in any of the ranges given in addition to any of the ranges given for plasticizer, where appropriate, to form many permutations that are within the scope of the present invention but that would be cumbersome to list.

Any figure reference numbers given within the abstract or any claims are for illustrative purposes only and should not be construed to limit the claimed invention to any one particular embodiment shown in any figure.

Figures are not drawn to scale unless otherwise indicated.

Each reference, including journal articles, patents, applications, and books, referred to herein is hereby incorporated by reference in its entirety.

We claim:

1. A polymer dispersion in water comprising:
water;
a poly(vinyl butyral) resin; and,
a surfactant having the formula 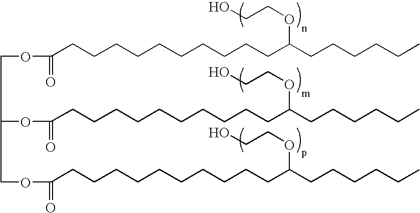
wherein n+m+p is 36-81 and n, m, and p are each 12 to 27.

2. The polymer dispersion of claim 1, wherein said polymer dispersion is a polymer suspension.

3. The polymer dispersion of claim 1, wherein said polymer dispersion is a polymer emulsion.

4. The polymer dispersion of claim 3, wherein the solids content of said dispersion is 10%-70%.

5. The polymer dispersion of claim 1, wherein the solids content of said dispersion is 20%-60%.

6. The polymer dispersion of claim 1, comprising 0.5-20 parts per hundred resin of said surfactant.

7. The polymer dispersion of claim 1, comprising 0.5-20 parts per hundred resin of said surfactant.

8. The polymer dispersion of claim 1, wherein n, m, and p are each 15-25.

9. The polymer dispersion of claim 1, wherein n, m, and p are each 18-22.

10. The polymer dispersion of claim 1, further comprising a second surfactant selected from the group consisting of sodium oleate, salts of the alkali metals, ammonium hydroxide, quaternary ammonium bases, triethanolamine, and morpholine.

11. The polymer dispersion of claim 1, further comprising fillers, modifying agents, starches, clays, natural gums, synthetic thickeners, pigments, antimicrobial agents, or ceramic powders.

12. A method of forming a polymer layer on a surface comprising:
providing said surface;
applying a polymer dispersion to said surface, wherein said polymer dispersion comprises:
water;
a poly(vinyl butyral) resin; and,
a surfactant having the formula 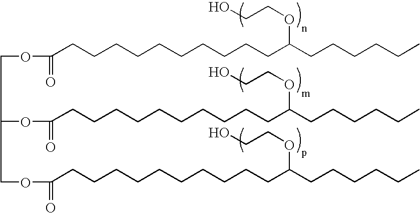
wherein n+m+p is 36-81 and n, m, and p are each 12-27; and,
evaporating some or all of said water to form said polymer layer.

13. The method of claim 12, wherein said polymer dispersion is a polymer suspension.

14. The method of claim 12, wherein said polymer dispersion is a polymer emulsion.

15. The method of claim 12, wherein the solids content of said dispersion is 10%-70%.

16. The method of claim 12, wherein the solids content of said dispersion is 20%-60%.

17. The method of claim 12, comprising 0.5-20 parts per hundred resin of said surfactant.

18. The method of claim 12, comprising 0.5-20 parts per hundred resin of said surfactant.

19. The method of claim 12, wherein n, m, and p are each 15-25.

20. The method of claim 12, wherein n, m, and p are each 18-22

21. A polymer layer formed by the process comprising the steps:
providing a surface;
applying a polymer dispersion to said surface, wherein said polymer dispersion comprises:
water;
a poly(vinyl butyral) resin; and,
a surfactant having the formula 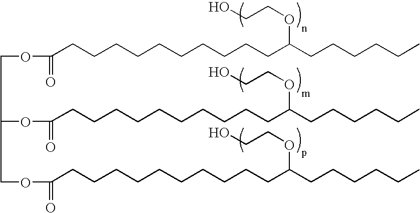
wherein n+m+p is 36-81 and n, m, and p are each 12-27; and,
evaporating some or all of said water to form said polymer layer.
